(19) United States
(12) Patent Application Publication
(10) Pub. No.: US 2004/0029623 A1
(43) Pub. Date: Feb. 12, 2004

(54) Cellular telephone and PDA carrying system

(76) Inventors: Janet Curry Ellis, Marina del Rey, CA (US); Diana Barbor, Van Nuys, CA (US)

Correspondence Address: CHRISTIE, PARKER & HALE, LLP, P.O. BOX 7068, PASADENA, CA, 91109-7068, US

(21) Appl. No.: 10/422,327

(22) Filed: Apr. 23, 2003

Related U.S. Application Data
(60) Provisional application No. 60/374,717, filed on Apr. 23, 2002.

(51) Int. Cl. H04M 1/00

(52) U.S. Cl. 455/575.8; 455/575.6

(57) ABSTRACT

A device for carrying mobile phones, PDAs, and other portable devices. The device includes a first attachment/detachment portion to be fixed to a back of the portable device. The attachment/detachment portion has a section of hook and loop, or double loop material. A second attachment/detachment portion has a second engagement portion that is attachably detachable to the first engagement portion, and further include a first fastener. A strap with second fastener is provided that clips to the first fastener.

### CROSS-REFERENCE TO RELATED APPLICATIONS

This patent application is based on and claims priority to U.S. Provisional Patent Application Serial No. 60/374,717, filed on Apr. 23, 2002.

### BACKGROUND OF THE INVENTION

The invention is in the field of devices such as cellular telephones and PDA accessories, and more particularly a cellular telephone and PDA carrying system which permits a user easy access to the device.

Cellular telephones and personal digital assistant (PDA) devices have grown in popularity in the U.S. and across the world over the last few years. Every year, tens of millions of cellular telephones and PDA devices are sold. While the size of these devices have generally shrunk, carrying these devices still present a concern. Various solutions have been developed to permit these devices to be worn on a person's clothing. For example, plastic holsters for holding cellular telephones and PDAs have become common, as are leather cases with belt clips. Holsters and clips may be fine while a person walks about, but if one sits down at a desk or in an automobile, the holster and clip may bind on the wearer and/or the device may come out. Moreover, if the user is not wearing a belt, for example, a woman wearing a dress without a belt, these holding devices cannot be used. Furthermore, these clips and cases may not complement a person's outfit. Some people carry their cellular telephone and PDA in a pocket. However, cellular telephones and PDAs carried in a pocket can be bulky and/or fall out. Furthermore, many garments such as some dresses, blouses, skirts, etc. do not have pockets. Others carry cellular telephones and PDAs in a purse, backpack or fanny pack. Carried as such, the cellular telephone and PDA can be difficult to retrieve quickly enough when the cellular phone rings to avoid the cellular telephone from being diverted. Also, if the purse is too small, the cellular telephone and PDA may not fit. Of course, if the user is not carrying a purse, fanny pack, backpack and the like, then he or she will not have that carrying option.

There accordingly remains a need for a cellular telephone, PDA and electronic device carrying system that can be worn by men or women, without or without pockets, belts, purses, backpacks, fanny packs, and the like, and which permits easy access to the device at a moment's notice while securely holding the electronic device.

### SUMMARY OF THE INVENTION

The invention provides a portable device, e.g. cellular telephone and PDA, carrying system that permits the device to be worn on a person's body, either on a shoulder strap, or on a belt loop.

In one aspect of the invention, an attachment/detachable means is affixed to the back of the cellular telephone or PDA, and a complementary detachable attachment means is affixed to a belt hanger strap.

In another aspect of the invention, an attachment/detachable means is affixed to the back of the cellular telephone, PDA or other electronic device, and a complementary detachable attachment means is affixed to one end of a shoulder strap. The shoulder strap can be provided in a variety of styles, colors, materials, and embellishments to coordinate with a user's outfit.

In yet another aspect of the invention, the attachment/detachable means comprises a section of hook and loop material (or double hook material) which is permanently adhesively attached to the back of the cellular telephone or PDA, such as by contact adhesive. The complementary detachable attachment means has a flexible or rigid section of material to which complementary hook and loop material (or double hook material) is attached. The complementary detachable/attachment means further has a hook, snap buckle, or other attachment means for attachment to a strap or chain, or to a short strap for engagement with a belt. A safety strap can be provided on the complementary detachable/attachment means as an added feature to prevent inadvertent separation of the cellular telephone or PDA device from the complementary detachable attachment means.

### BRIEF DESCRIPTION OF THE DRAWINGS

FIG. 1 is a front plan view of a first embodiment of a cellular telephone, PDA, or other electronic device carrying system of the invention.

FIG. 2 is a back plan view of a sample cellular telephone with the detachable attachable means affixed thereto.

FIG. 3 is a side view of the exemplary cellular telephone secured to the electronic device carrying system of the invention.

FIG. 4 is a front plan view of a second embodiment of a cellular telephone, PDA, or other electronic device carrying system of the invention.

FIG. 5 is a back plan view of the electronic device carrying system of FIG. 4.

FIG. 6 is a front plan view of the electronic device carrying system of FIG. 4 with the carrying strap attached thereto.

FIG. 7 is a back plan view of a third embodiment of the electronic device carrying system.

FIG. 8A is a back plan view of a fourth embodiment of the electronic device carrying system.

FIG. 8B is a back plan view of a fifth embodiment of the electronic device carrying system.

FIG. 9 is a front view of a cellular telephone carried on the electronic device carrying system.

FIG. 10 is a front plan view of a chain with a male portion of a buckle on a chain for use with the electronic device carrying system.

FIG. 11 is a front plan view of a sixth embodiment of the electronic device carrying system.

FIG. 12 is a front perspective view of a portion of a seventh embodiment of an electronic device carrying system.

FIG. 13 is a side view of the electronic device carrying system of FIG. 12 being used to carry a cellular telephone and engaged with a belt.

FIG. 14 is a front view of the accessory carrying pouch on a strap of the electronic device carrying system.

FIG. 15 is a back plan view of the accessory carrying pouch on a strap of FIG. 14.

### DETAILED DESCRIPTION OF THE INVENTION

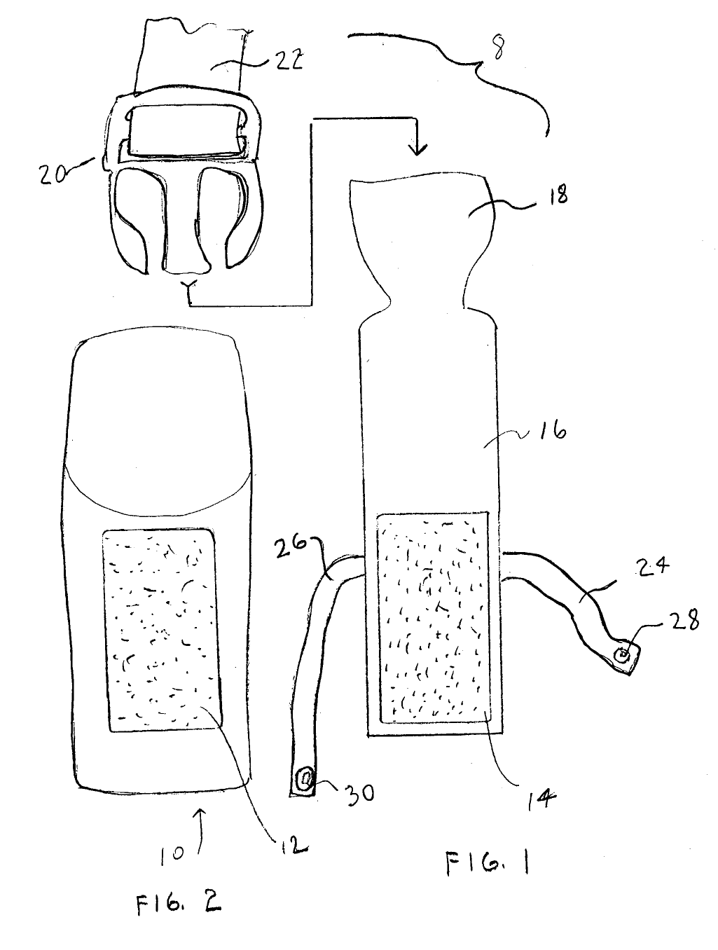

FIG. 1 is a front plan view of a first embodiment of a cellular telephone, PDA, or other portable device carrying system 8 of the invention, for attachment to a portable electronic device 10, such as a cellular telephone (shown in FIG. 2) or a PDA. A section of detachably/attachable engagement material 12, such as hook and loop material (e.g. Velcro®) or double hook material, is attached to the back of the electronic device 10, e.g. by adhesive. A complementary detachable engagement material 14, such as hook and loop material or double hook material, is attached to a body portion 16, which can have a first integrally formed interlock snap buckle portion 18. The body portion 16 and its integral interlock snap buckle portion 18 can be formed of plastic. A second interlock snap buckle portion 20 which engages with the first integrally formed interlock snap buckle portion 18 is engaged with a carrying strap 22. Optional security straps 24 and 26 extend from the body portion 16, and can have snaps 28 and 30 or other retention means or detachable attachment means, such as hook and loop material, hooks, etc. (not shown) to permit the security straps 24 and 26 to be attached together around the portable device 10.

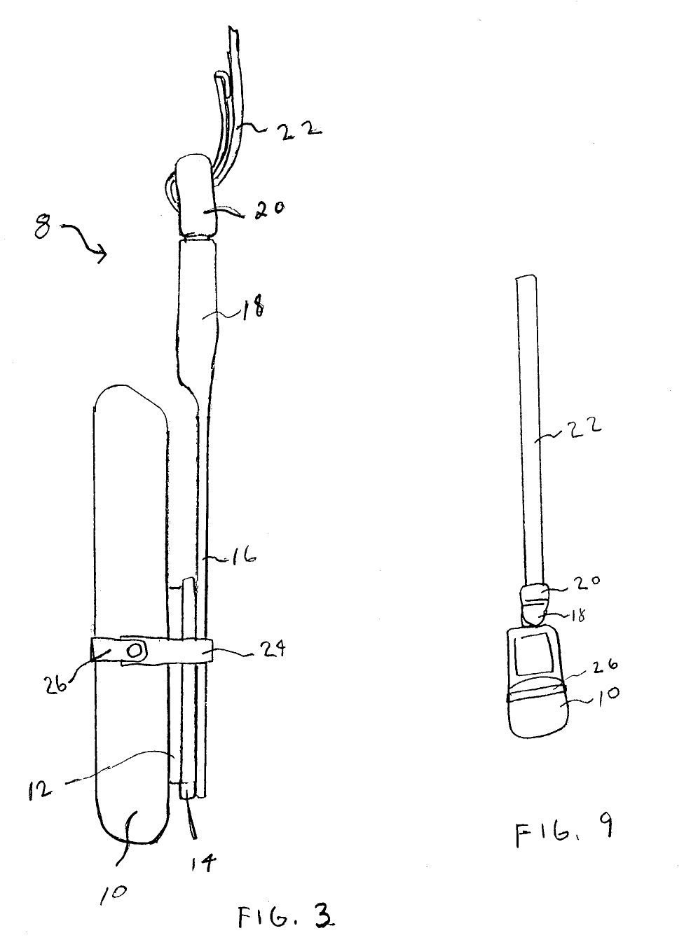

FIG. 3 is a side view of the cellular telephone 10 secured to the electronic device carrying system 8, with the detachable engagement material 12 on the back of cellular telephone 10 being engaged with the complementary detachable engagement material 14 on the front of the body portion 16. The security straps 24 and 26 are engaged by their snaps 28 and 30 to help prevent the cellular telephone 10 from becoming inadvertently separated from the portable device carrying system 8.

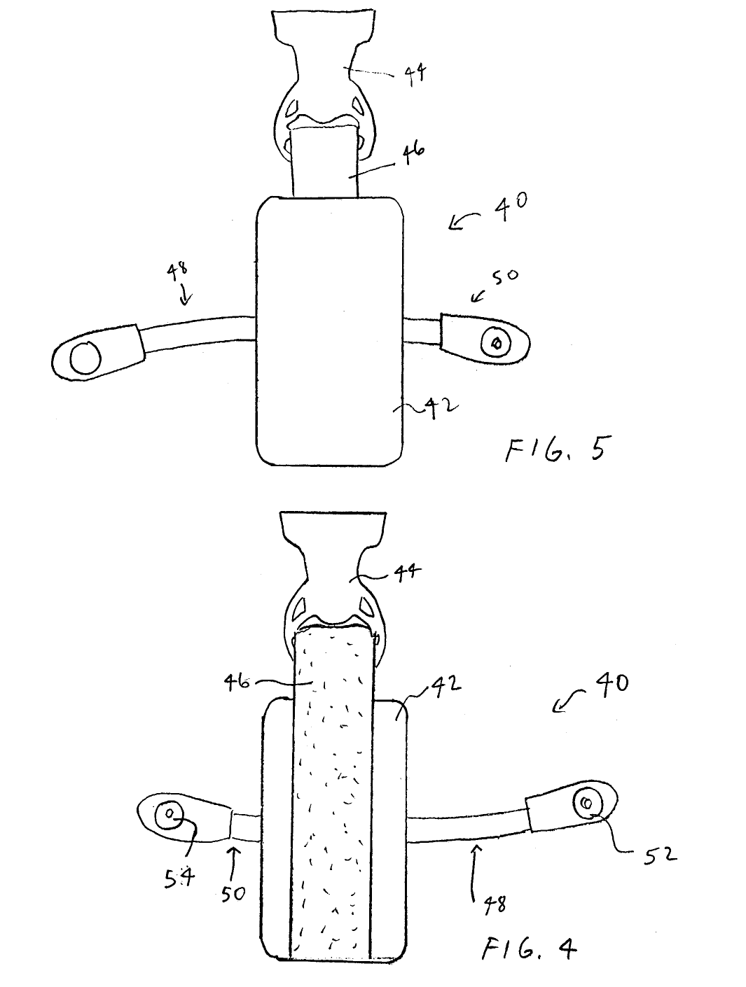

FIGS. 4 and 5 are a front and back plan view, respectively, of a second embodiment of a cellular telephone, PDA, or other electronic device carrying system 40 of the invention. In this embodiment, rather than being integrally formed with a body portion 42, an interlock snap buckle portion 44 is attached to the body portion 42 by a strap 46, which can comprise a portion of the detachable engagement material 12, such as hook and loop material or double hook material, or can comprise a separate section of material. Optional safety straps 48 and 50 with snaps 52 and 54 extend from the body portion 42. The body portion 42 can be formed of materials such as leather, vinyl, plastic, fabrics, etc.

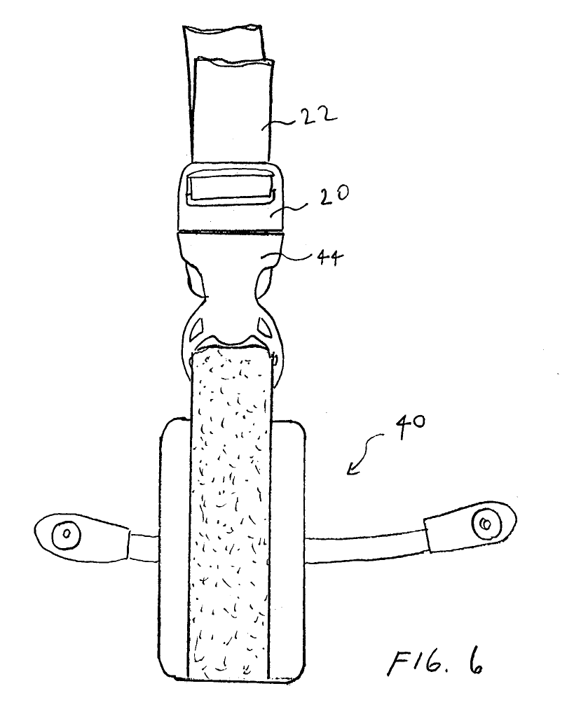

FIG. 6 is a front plan view of the electronic device carrying system 40 of FIG. 4 with the carrying strap 22 on the second interlock snap buckle portion 20 engaged to first interlock snap buckle portion 20.

FIG. 7 is a back plan view of a third embodiment of the electronic device carrying system 50. The embodiment has a detachable engagement strap 52, which is attachable to a body portion 54 with an engagement means 54, such as a screw. However, any other engagement means, such as clips, clasps, hooks, hook and loop material, etc., can be used.

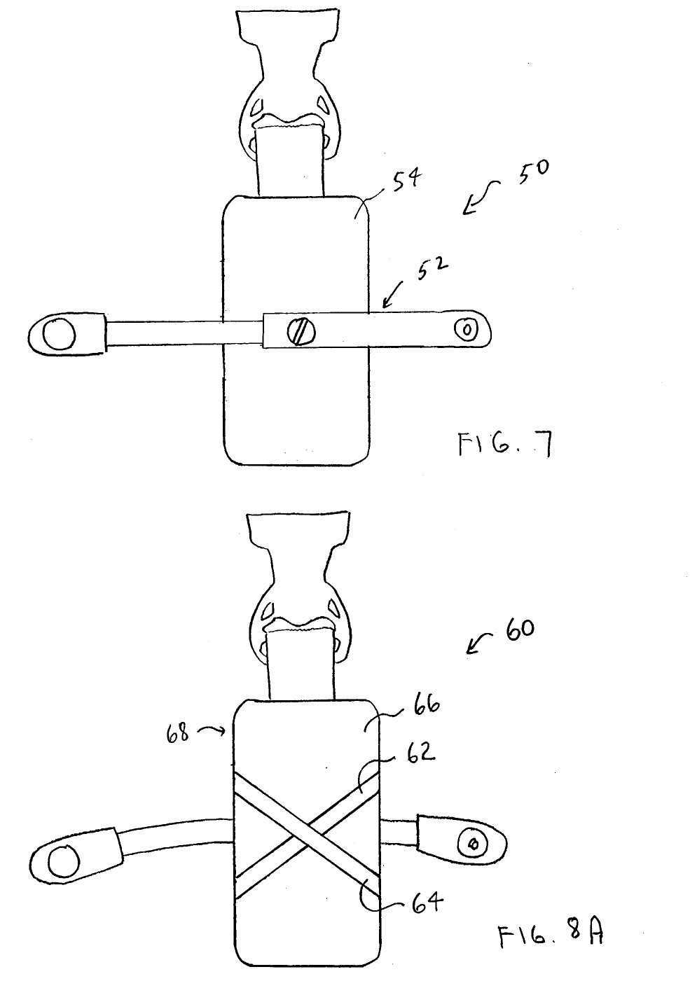

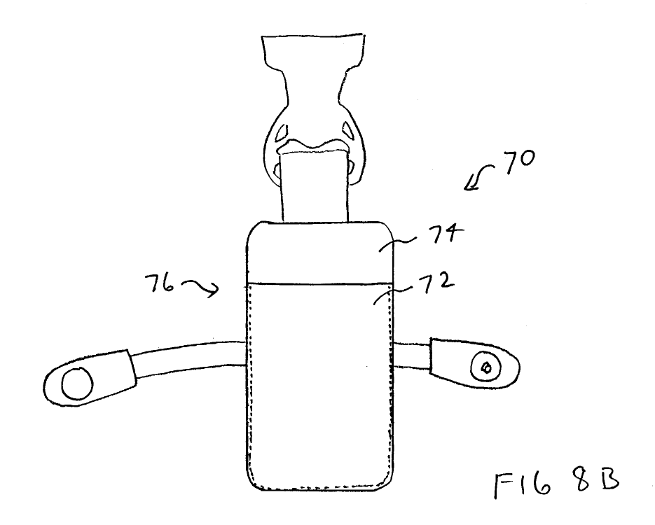

FIG. 8A is a back plan view of a fourth embodiment of the electronic device carrying system 60, which has elastic straps 62 and 64 that extend over a back 66 of a body portion 68. The elastic straps 62 and 64 are provided to permit small items, such a small wad of folded paper money, a driver's license, credit cards, any earphone and microphone unit or cord thereof, etc. to be securely carried on the back 66 of the body portion 68.

FIG. 8B is a back plan view of a fifth embodiment of the electronic device carrying system, which has a pocket made of elastic material 72 on a back 74 of a body portion 76 thereof. As with the fourth embodiment 60, the pocket 72 is provided to permit small items, such a small wad of folder paper money, a driver's license, credit cards, any earphone and microphone unit or cord thereof, etc. to be securely carried on the back of the body portion 76 of the device.

FIG. 9 is a front view of a cellular telephone 10 carried on the electronic device carrying system 8. As can be seen, the security straps 24 and 26 will act to restrain the cellular telephone and prevent it from inadvertently becoming separated.

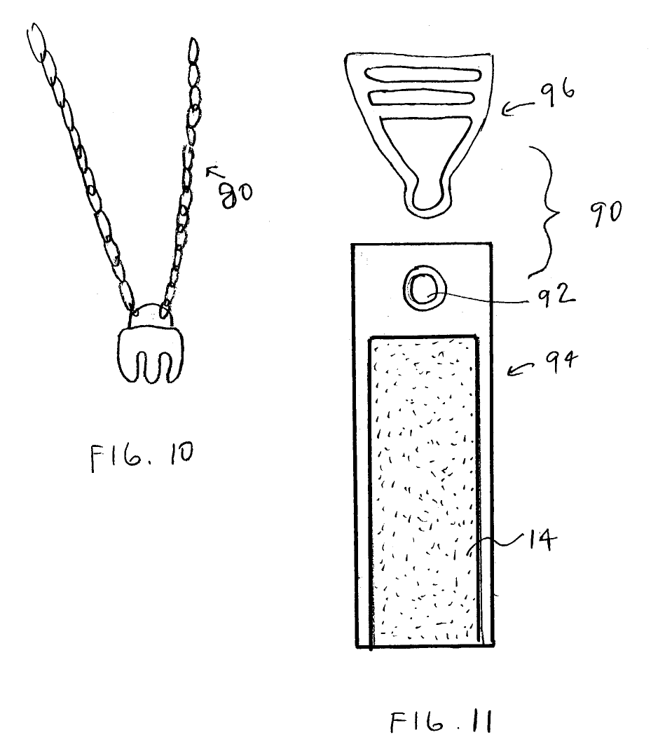

FIG. 10 is a front plan view of a chain 80 with the second interlock snap buckle portion 20 attached thereto. In practice, the system can be provided with any number of styles of straps, chains, and the like to match a person's outfit. For example, for formal events, a very sleek and stylish chain or other elongate materials can be used. The second interlock snap buckle portion 20 will be adapted to engage with the rest of the system. If desired, the user can provide his or her own elongate materials as the strap portion.

FIG. 11 is a front plan view of a sixth embodiment of the electronic device carrying system 90, which instead of using snap buckles, uses a button 92 on a body portion 94, and has a clasp 96 which detachably engages with the button to prevent inadvertent detachment of the body portion 94 from the clasp 96. Preferably, the button and clasp engagement permits movement of the body portion 94 relative to the clasp 96. As with other embodiments, the body portion 94 carries the electronic device.

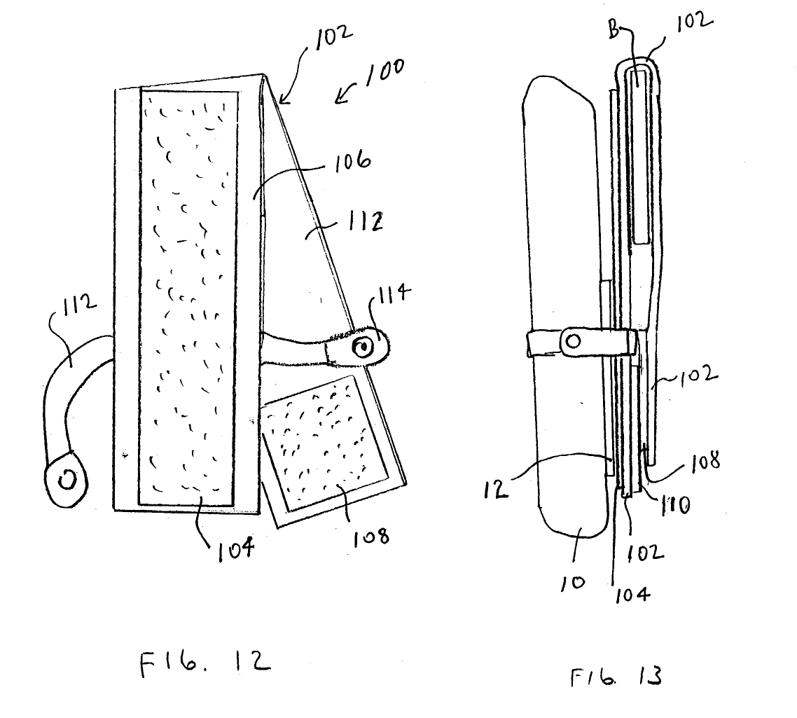

FIG. 12 is a front perspective view of a portion of a seventh embodiment of the electronic device carrying system 100, which has a strap 102 with a section of detachable engagement material 104, such as hook and loop material or double hook material, attached to a front surface 106 of the strap. Detachable attachment means 108 and 110, such as sections of hook and loop material or double hook material are attached to portions of the back face 112 of the strap 102 (See FIG. 13 for section 110.) Optional safety straps 112 and 114 are provided.

FIG. 13 is a side view of the electronic device carrying system 100 used to carry a cellular telephone 10, and looped around a wearer's belt B. The sections of detachable attachment means 108 and 110 hold the strap 102 around the belt B, and the detachable engagement material 104 engages with the detachable engagement material 12 on the back of the cellular telephone.

Of course, while the discussion of the various embodiments has been focused on cellular telephones, the device can be used with PDA, cameras, personal music players, radios, etc.

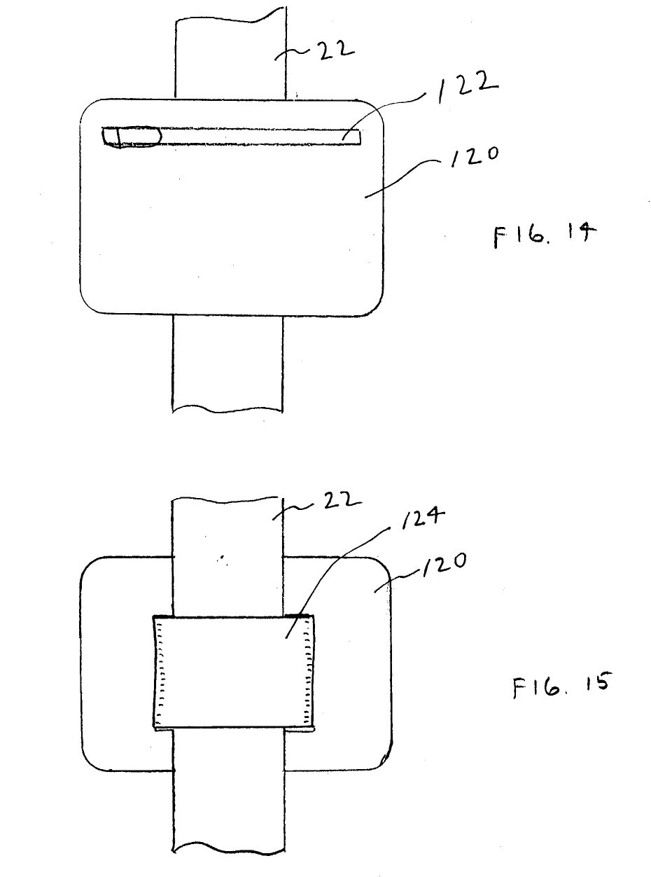

While the embodiments of FIGS. 8A and 8B have means to carry small items on the back of the body portions thereof 54 and 66, there can be provided an accessory carrying pouch 120 (e.g. with a zipper 122) which can be retained on the carrying strap 22, as shown in FIGS. 14 and 15, of which FIG. 14 is a front view and FIG. 15 is a rear view thereof. A retention means 124 can be used to hold the accessory carrying pouch 120 on the strap 22, and can permit the accessory carrying pouch 120 to be slidably moved on the strap 22. A similar type of pouch could also be provided to be carried directly on the body portion of the various embodiments, if desired.

The safety straps shown in the various embodiments are merely representative of the sizes and shapes of possible safety straps. For example, a continuous band of flexible material could be used to wrap around the electronic device being restrained. Alternatively, resilient arms could be incorporated into the design of the body portion to prevent inadvertent separation of the device from the body portion.

Having thus described exemplary embodiments of the present invention, it should be understood by those skilled in the art that the above disclosures are exemplary only and that various other alternatives, adaptations and modifications may be made within the scope of the present invention. The presently disclosed embodiments are to be considered in all respects as illustrative and not restrictive. The scope of the invention being indicated by the claims, rather than the foregoing description, and all changes which come within the meaning and range of equivalency of the claims are therefore intended to be embraced therein.

We, claim:

1. A device for carrying a portable device, comprising:
a first attachment/detachment means to be fixed to a back of the portable device, the attachment/detachment means having a first engagement means;
a second attachment/detachment means having a second engagement means that is attachably detachable to the first engagement means, the second attachment means further including a first fastener portion; and
a strap with second fastener portion.

2. The device of claim 1, wherein the first attachment/detachment means comprises one of a hook and loop material, and the second attachment/detachment means comprises the other of a hook and loop material.

3. The device of claim 2, wherein the first attachment/detachment means is adhesively affixed to the back of the portable device.

4. The device of claim 1, wherein each of the first and second attachment/detachment means comprises double hook material.

5. The device of claim 4, wherein double hook material is adhesively affixed to the back of the portable device.

6. The device of claim 1, wherein the second attachment/detachment means comprises a unitary plastic structure that incorporates the first fastener portion.

7. The device of claim 1, wherein the first and second fasteners portions are snap buckles.

8. The device of claim 1, wherein the second attachment/detachment means further comprises a retention strap.

9. The device of claim 8, wherein the second attachment/detachment means further comprises two retention straps with fasteners at free ends thereof.

10. The device of claim 1, further comprising elastic strips connected to a body portion of the second attachment/detachment means.

11. The device of claim 10, wherein the body portion includes a pocket.

12. The device of claim 1, further including a pouch that is retained on the strap.

13. The device of claim 1, wherein the second attachment/detachment means comprises a strip of one of hook and loop material attached to a body portion and connected to a lower end of the first buckle portion.

14. The device of claim 1, wherein the second attachment/detachment means comprises a strip of one of hook and loop material attached to a body portion, with the first fastener portion comprising a button, and the second fastener portion comprising a clasp that snaps to the button.

15. A device for carrying a mobile phone or PDA, comprising:
a first attachment/detachment means to be fixed to a back of the mobile phone or PDA, the attachment/detachment means having a first engagement means;
a second attachment/detachment means having a second engagement means that is attachably detachable to the first engagement means.

16. The device of claim 15, further comprising a first fastener attached to the second attachment means and a second fastener attached to a strap means.

17. The device of claim 15, wherein the first engagement means and the second engagement means comprise one of hook and loop, and double hook material.

18. The device of claim 15, wherein the second attachment/detachment means comprises a strip of one of hook and loop material and double hook material.
